(19) United States
(12) Patent Application Publication
(10) Pub. No.: US 2008/0164937 A1
(43) Pub. Date: Jul. 10, 2008

(54) BAND GAP REFERENCE CIRCUIT WHICH PERFORMS TRIMMING USING ADDITIONAL RESISTOR

(75) Inventor: Hyung-seuk KIM, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 11/872,118

(22) Filed: Oct. 15, 2007

(30) Foreign Application Priority Data
Jan. 4, 2007 (KR) 10-2007-0001187

(51) Int. Cl. G05F 3/02; G05F 1/10

(52) U.S. Cl. 327/539

(57) ABSTRACT

A band gap reference circuit incorporating resistive trimming is disclosed. The band gap reference circuit includes an additional trimming resistor and a trimming unit which performs trimming by changing a resistance value of the trimming resistor.

### CROSS-REFERENCE TO RELATED PATENT APPLICATION

This application claims the benefit of Korean Patent Application No. 10-2007-0001187 filed on Jan. 4, 2007, the subject matter of which is hereby incorporated by reference.

### BACKGROUND OF THE INVENTION

1. Field of the Invention

The present invention finds application in the provision of certain voltage signals with semiconductor devices. More particularly, the invention relates to a band gap reference circuit having an output compensated for temperature by the use of resistive trimming.

2. Description of the Related Art

It is well understood that the characteristics of a power supply voltage provided to circuits within a semiconductor device will vary over time. A principal cause for such variations is the fluctuation of ambient temperature conditions around circuits providing the power supply voltage. Indeed, as many semiconductor devices operate, they generate heat which causes fluctuations in the ambient temperature conditions. However, stability of the power supply voltage(s) within a semiconductor device is critical to the proper operation of the device. Accordingly, various compensation mechanisms or circuits are used to ensure power supply voltage stability over a range of operating temperatures. One such circuit is the band gap reference circuit which is commonly used to stabilize power supply voltages within semiconductor devices.

Figure (FIG.) 1 is a circuit diagram illustrating in relevant portion a conventional band gap reference circuit 10 which incorporates a “trimming” functionality.

Within the context of the circuit shown in FIG. 1, a reference current (Iref) (i.e., the current “Ia” flowing through a first MOS transistor P1 or current “Ib” flowing through a second MOS transistor P2) for band gap reference circuit 10 may be calculated according to Equation 1 below:

$$\begin{matrix}\begin{matrix}Iref = I 1 + I 2 \\ = {V}_{EB} / R 2 + {V}_{T} ln ( N ) / R 1\end{matrix} & ( 1 )\end{matrix}$$

Here, the emitter-base voltage VEB has a negative temperature coefficient, and thus the emitter-base voltage VEB decreases as temperature increases. In contrast, heat voltage VT has a positive temperature coefficient, and thus the heat voltage VT increases as temperature increases.

Accordingly, band gap reference circuit 10 generates reference current Iref that is relatively unaffected by temperature change. This result is accomplished by suitably defining the values of regulating resistors R1 and R2 (and therefore first and second currents I1 and I2) in order to properly balance changes in the heat voltage VT and the emitter-base voltage VEB as a function of temperature. This balance is conceptually illustrated in FIG. 2. Thus, the conventional band gap reference circuit 10 may change the value of resistor R1 to accurately trim the balancing first and second currents.

FIG. 3 is a diagram illustrating in relevant portion a conventional trimming method that uses a CMOS switch. Referring to FIG. 3, a resistance value of R1 may be defined using the CMOS switch which is in response to a mode resistor set (MRS) signal. The CMOS switch may be implemented using NMOS transistors. The resulting resistance provide by the CMOS switch may be modeled as an equivalent resistance R(T), defining a transistor drain/source voltage VDS, as illustrated in FIG. 4A. However, voltage VDS is very sensitive to temperature. Accordingly, the equivalent resistance R(T) may vary with time as illustrated in FIG. 4B.

A reference current that accurately models the combined effects of resistive trimming and temperature change is given below in Equation 2. Here, the characteristics of a band gap reference circuit are defined in part by VEB that decreases with a slope of approximately 2 mV/T, and VTIn(N) that increases with a slope of approximately 0.2 mV.

$$\begin{matrix}\begin{matrix}Iref = I 1 + I 2 \\ = ( {V}_{EB 0} - 2 mV / T ) / R 2 + \\ ( {V}_{T 0} ln ( N ) + 0.2 mV / T ) / R 1 + R ( T ) )\end{matrix} & ( 2 )\end{matrix}$$

Referring to Equation 2, the reference current of band gap reference circuit 10 is nonlinear, as illustrated in FIG. 5, due to changes in the resistance component R(T) caused by trimming by means of the CMOS switch.

An error value Err of a nonlinear component of the reference current of band gap reference circuit 10 may be obtained using Equation 3 below.

Err=(−2 mV/T)/R2+(0.2 mV/T)/(R1+R(T)) (3)

Simulation results have suggested that the error value Err of Equation 3 may exceed several μA.

### SUMMARY OF THE INVENTION

Embodiments of the present invention provide a band gap reference circuit incorporating resistive trimming that is capable of generating a stable reference current.

In one embodiment, the invention provides a band gap reference circuit generating a reference voltage, comprising; first and second MOS transistors responsive to a bias voltage and respectively generating outputs at a first and second voltage node, first and second diodes respectively series connected between the first and second MOS transistors and ground, a first resistor connected between the second voltage node and the second diode, a second resistor connected in parallel with the first resistor and the second diode between the second voltage node and ground, a trimming resistor having a variable resistance defined by a trimming unit and connected between the first voltage node and the first diode, and a third resistor connected in parallel with the trimming resistor and the first diode between the first voltage node and ground.

### BRIEF DESCRIPTION OF THE DRAWINGS

FIG. 1 is a circuit diagram illustrating a part of a conventional band gap reference circuit which performs trimming;

FIG. 2 is a conceptual graph of an ideal reference current of the band gap reference circuit of FIG. 1;

FIG. 3 is a diagram illustrating a conventional trimming method using a CMOS switch;

FIGS. 4A and 4B respectively illustrate an equivalent resistance and temperature change of the CMOS switch of FIG. 3;

FIG. 5 is a conceptual graph of a reference current of FIG. 1 reflecting changes in a resistance component caused by trimming;

FIG. 6 is a circuit diagram illustrating a part of a band gap reference circuit performing trimming according to an embodiment of the present invention; and

FIG. 7 is a graph illustrating an improved operation characteristic of the band gap reference circuit of FIG. 6.

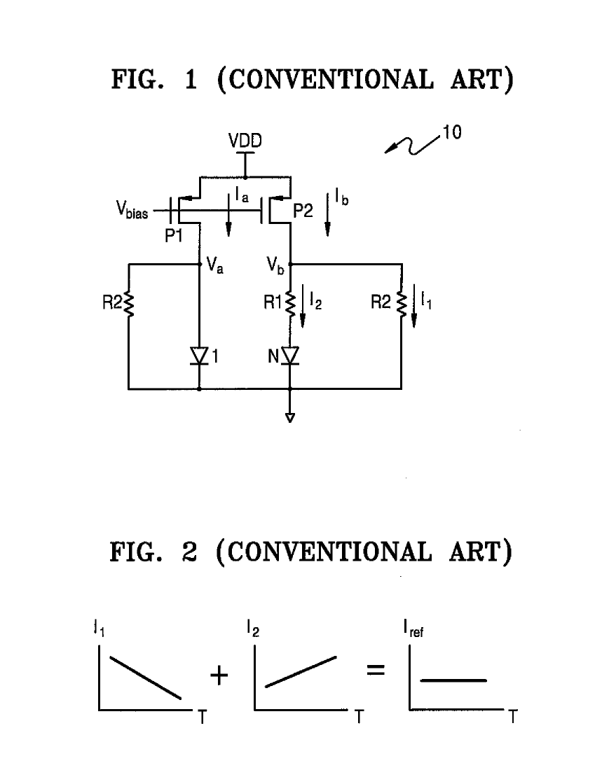

### DESCRIPTION OF EMBODIMENTS

Embodiments of the invention will be described with reference to the accompanying drawings. Throughout the drawings and written description, like reference numerals and labels indicate like or similar elements.

FIG. 6 is a circuit diagram illustrating in relevant portion a band gap reference circuit 100 incorporating resistive trimming according to an embodiment of the present invention.

Referring to FIG. 6, band gap reference circuit 100 comprises first and second MOS transistors P1 and P2, first and second diodes D1 and D2, and first through third resistors R1 through R3. Here, first and second MOS transistors P1 and P2 are PMOS transistors and the resistance of second resistor R2 is larger than the resistance of first resistor R1. Band gap reference circuit 100 operates in conjunction with trimming unit 200.

Band gap reference circuit 100 may operate in relation to an operational amplifier (not shown) in which a first node voltage Va and a second node voltage Vb are inputs to a non-inverting terminal and an inverting terminal, respectively. Bias voltage Vbias is the output of the operational amplifier.

An emitter area ratio between forward biased first and second diodes D1 and D2 is defined as 1:N, and the width/length ratio for each one of first and second MOS transistors P1 and P2 is assumed to be equal. Accordingly, the current flowing through the first and second diodes will be equal (i.e., I2=I4).

The resistance of third resistor R3 is assumed to be equal to the resistance of second resistor R2, such that first node voltage Va and second node voltage Vb are equal and the current flowing through first, second, and third resistors R1, R2, and R3 are also equal (i.e., I1=I3). Accordingly, first and second current flowing through first and second MOS transistors P1 and P2 is equal (i.e., Ia=Ib).

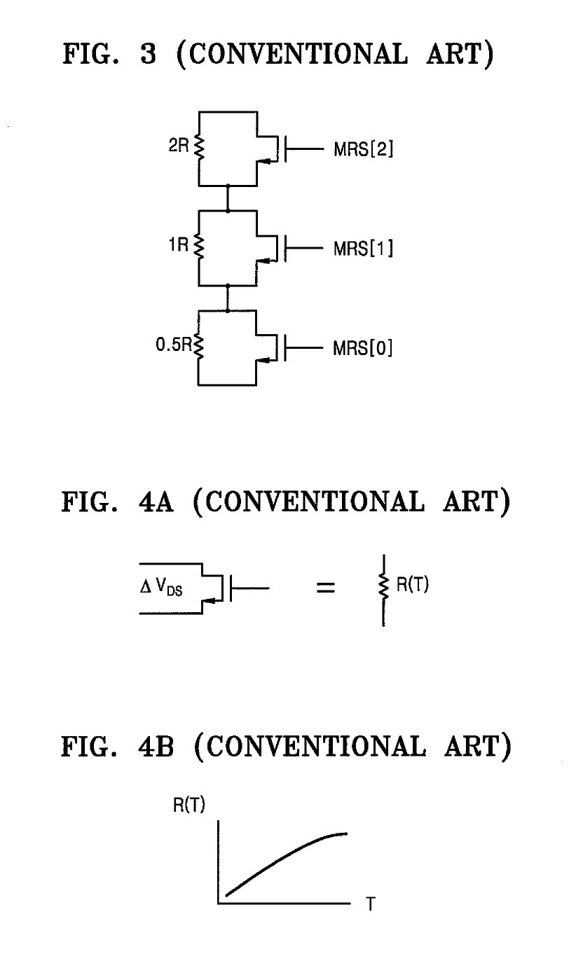

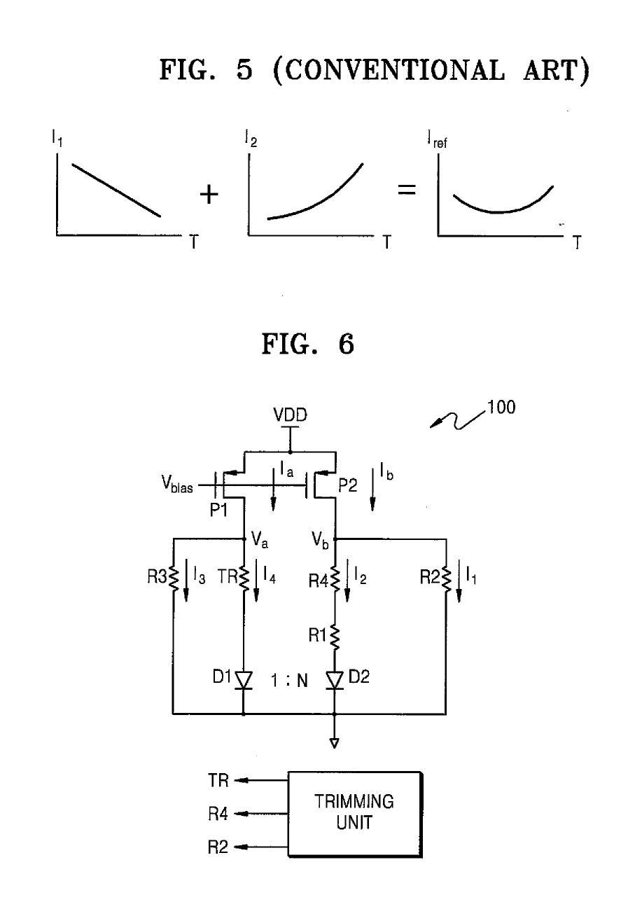

In order to perform resistive trimming, band gap reference circuit 100 of FIG. 6, also comprises a trimming resistor TR series connected between first MOS transistor P1 and first diode D1. Trimming unit 200 may be used to perform trimming of band gap reference circuit 100 by changing a resistance value of at least the trimming resistor TR. In this regard, trimming unit 200 may be conventionally implemented using one or more CMOS switches that change the resistance value of the trimming resistor TR. For example, the CMOS switches may be implemented using NMOS transistors, and may be switched in response to a conventional mode resistor set (MRS) signal. That is, trimming unit 200 may be realized in a manner similar to that shown in FIG. 3.

The process of defining the reference current Iref to have the relationship Iref=Ia=Ib according to the value of trimming resistor TR may be better understood from a consideration of Equations 4 through 7 below.

$$\begin{matrix}\begin{matrix}Iref = I 1 + I 2 \\ = Vb / R 2 + I 2\end{matrix} & ( 4 )\end{matrix}$$

First node voltage Va and second node voltage Vb are again assumed to be equal, and since first node voltage Va in the illustrated example is V_{EB}+TR×I4, Equation 4 may be rewritten as Equation 5.

Iref=(V_{EB}+TR×I4)/R2+I2 (5)

Since the current flowing through second resistor R2 and third resistor R3 are equal (I1=I3), Equation 5 may be rewritten as Equation 6.

$$\begin{matrix}\begin{matrix}Iref = {V}_{EB} / R 2 + ( TR \times I 2 ) / R 2 + I 2 \\ = {V}_{EB} / R 2 + I 2 \times ( R 2 + TR ) / R 2\end{matrix} & ( 6 )\end{matrix}$$

Referring back to Equation 1, I2 is equal to V_{T} ln(N)/R1, and thus an expression of the reference current Iref may be written as Equation 7.

Iref=V_{EB}/R2+(R2+TR)V_{T} ln(N)/(R1×R2) (7)

As described in Equation 2, VEB decreases with a slope of approximately 2 mV/T and VTln(N) increases with a slope of approximately 0.2 mV. Thus, an error value (Err) for the nonlinear component of the reference current Iref may be written as Equation 8.

Err=(−2 mV/T)/R2+(R2+TR)×(0.2 mV/T)/(R1×R2) (8)

Since band gap reference circuit 100 performs trimming using the trimming resistor TR, the actual resistance of the trimming resistor TR can be expressed by Equation 9, where the equivalent resistance of the CMOS switch is indicated by FIG. 4.

TR+R(T)=r3+cT (9)

In Equation 9, r3 and c are constants and T is temperature. Substituting Equation 9 into Equation 8, an error value (ERR) for the nonlinear component may be given as Equation 10.

Err=(−2 mV/T)/R2+(R2+r3+cT)(0.2 mV/T)/(R1×R2) (10)

Comparing Equation 10 and Equation 3, the resistance value of second resistor R2 is approximately 10 times larger than the resistance value of first resistor R1, and thus the resistance value of the trimming resistor TR is smaller than the resistance value of first resistor R1. Accordingly, the error value of Equation 6 is relatively less affected by temperature.

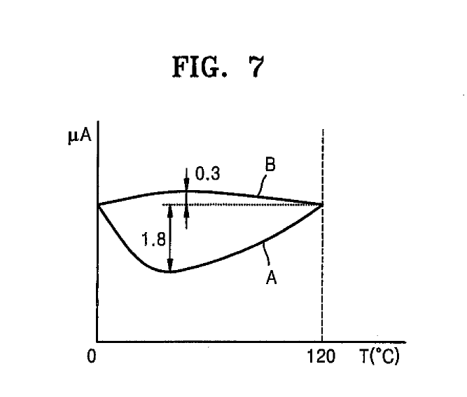

FIG. 7 is a graph illustrating the improved operating characteristics of the band gap reference circuit 100 shown in FIG. 6.

Referring to a simulation result B in FIG. 7 for the reference current in band gap reference circuit 100 when trimming is performed across a temperature range of 0° C. to 120° C., the error value derived from Equation 10 is only about 0.3 μA. Accordingly, the stability provided by band gap reference circuit 100 is remarkably improved when comparing the simulation result B with a simulation result A for a conventional band gap reference circuit which has a calculated error value of about 1.8 μA.

Band gap reference circuit 100 of FIG. 6 may also perform trimming in relation to a fourth resistor R4, because additional trimming may be required since the resistance value of the trimming resistor TR is smaller than the resistance of the first resistor R1.

As described above, a band gap reference circuit according to an embodiment of the present invention performs trimming using an additional resistor relative to the conventional design and is less sensitive to variations in temperature. Accordingly, the band gap reference circuit is able to better generate a stable reference voltage.

While the present invention has been particularly shown and described with reference to exemplary embodiments thereof, it will be understood by those of ordinary skill in the art that various changes in form and details may be made therein without departing from the scope of the present invention as defined by the following claims.

What is claimed is:

1. A band gap reference circuit generating a reference voltage, comprising:
first and second MOS transistors response to a bias voltage and respectively generating outputs at a first and second voltage node;
first and second diodes respectively series connected between the first and second MOS transistors and ground;
a first resistor connected between the second voltage node and the second diode;
a second resistor connected in parallel with the first resistor and the second diode between the second voltage node and ground;
a trimming resistor having a variable resistance defined by a trimming unit and connected between the first voltage node and the first diode; and
a third resistor connected in parallel with the trimming resistor and the first diode between the first voltage node and ground.

2. The band gap reference circuit of claim 1, wherein the trimming unit comprises at least one CMOS switch connected to the trimming resistor.

3. The band gap reference circuit of claim 2, wherein the at least one CMOS switch is implemented using at least one NMOS transistor.

4. The band gap reference circuit of claim 2, wherein the at least one CMOS switch is switched in response to a mode resistor set (MRS) signal.

5. The band gap reference circuit of claim 1, wherein the resistance value of the trimming resistor is smaller than the resistance value of the first resistor and the resistance value of the second resistor.

6. The band gap reference circuit of claim 1, further comprising a fourth resistor series connected with the first resistor between the second voltage node and the second diode.

7. The band gap reference circuit of claim 6, wherein a resistance value of the fourth value is equal to the resistance value of the trimming resistor.

8. The band gap reference circuit of claim 1, wherein an error value (Err) for a nonlinear component of the reference voltage is expressed as Err=(−2 mV/T)/R2+(R2+r3+cT)(0.2 mV/T)/(R1×R2), where R1 and R2 are respectively the resistance values of the first and second resistors, and r3+cT is the resistance of the trimming resistor, where r3 and c are constants and T is the ambient operating temperature of the band gap reference circuit.

9. The band gap reference circuit of claim 8, wherein R2 is greater than R1.

10. The band gap reference circuit of claim 1, wherein the first and second MOS transistors are PMOS transistors.

11. The band gap reference circuit of claim 1, wherein an emitter area ratio for the first and second diodes is 1:N.

12. The band gap reference circuit of claim 1, wherein equal current flows through the first and second diodes.

13. The band gap reference circuit of claim 2, wherein the trimming unit comprises a first trimmer changing the resistance value of the trimming resistor, and a second trimmer changing the resistance value of the second resistor.

14. The band gap reference circuit of claim 13, wherein the first and second trimmers each comprise CMOS switches respectively connected to the trimming resistor and the second resistor.

15. The band gap reference circuit of claim 14, wherein the CMOS switches are switched in response to an MRS signal.

16. The band gap reference circuit of claim 13, wherein the resistance value of the trimming resistor is smaller than the resistance values of the first and second resistors.

17. The band gap reference circuit of claim 13, further comprising a fourth resistor series connected with the first resistor between the second voltage node and the second diode.

18. The band gap reference circuit of claim 17, wherein a resistance value of the fourth resistor is equal to the resistance value of the trimming resistor.
